(19) United States
(12) Patent Application Publication
(10) Pub. No.: US 2007/0123219 A1
(43) Pub. Date: May 31, 2007

(54) SYSTEM AND METHOD FOR ITEM IDENTIFICATION AND PURCHASE

(75) Inventor: Robert C. Lovell JR., Leesburg, VA (US)

Correspondence Address: PAUL, HASTINGS, JANOFSKY & WALKER LLP, P.O. BOX 919092, SAN DIEGO, CA, 92191-9092, US

(73) Assignee: Mobile 365, Inc., Chantilly, VA (US)

(21) Appl. No.: 11/550,651

(22) Filed: Oct. 18, 2006

Related U.S. Application Data
(60) Provisional application No. 60/727,858, filed on Oct. 19, 2005.

(51) Int. Cl. H04L 12/58; H04M 1/725; H04Q 7/22

(52) U.S. Cl. 455/412.1

(57) ABSTRACT

A method and system for handling message-based requests for information about items, and for handling optional message-based purchases of same, includes receiving a request message from a mobile subscriber relating to an item that is of interest to the mobile subscriber, routing the request message for processing, performing one or more activities in accordance with the request message, and returning one or more response messages to the mobile subscriber.

This application claims the benefit of U.S. Provisional Patent Application No. 60/727,858, filed on Oct. 19, 2005, which is herein incorporated by reference in its entirety.

### BACKGROUND

1. Field of the Invention

The present invention relates generally to telecommunications services. More particularly, the present invention relates to the utilization of various wireless messaging paradigms including, inter alia, Short Message Service (SMS) and Multimedia Message Service (MMS) to facilitate the identification and the optional purchase of items.

2. Background

While the ‘wireless revolution’ continues to march forward, it carries with it a range of untapped, or under-exploited, potentials. As the various technological (e.g., ubiquitous cross-carrier interoperability), social (e.g., user or subscriber inertia), etc. impediments are breached, wireless data services continue to grow and continue to provide significant revenue opportunities to Wireless Carriers (WCs). To sustain that growth, a continual stream of new ‘singular’ wireless data products and services is required.

### BRIEF SUMMARY OF THE INVENTION

The present invention is related to a product/service that allows a Mobile Subscriber (MS), a user of a Wireless Device (WD, such as, for example, a mobile telephone), to quickly and conveniently obtain information (including possibly among other things, description, price, availability, etc.) about an item of interest (using, for example, the Universal Product Code [UPC] or bar code from the item) and optionally purchase the item.

The present invention is related to various of the challenges (including, inter alia, object identification, payment, etc.) that naturally arise from such an offering,

In accordance with one aspect of the present invention, a method for providing information to a wireless device user, comprises receiving an item inquiry message from a wireless service provider associated with the user at a messaging inter-carrier vendor, forwarding the item inquiry message to a service provider, receiving an inquiry response message from the service provider at the messaging inter-carrier vendor, the inquiry response message including information associated with the item of interest, and routing the inquiry response message from the messaging inter-carrier vendor to the wireless service provider.

According to another exemplary aspect of the present invention, a method of registering a mobile device user associated with a wireless carrier with a service provider comprises storing identification information associated with the mobile device user at a database of the service provider, receiving an acceptance message at an inter-carrier provider, routing the acceptance message from the inter-carrier provider to the wireless carrier, receiving a reply message from the wireless carrier at the inter-carrier provider, forwarding the reply message to the service provider, and updating user entries at the service provider.

According to another exemplary aspect of the present invention, a method for facilitating a purchase of an item of interest by a user of a wireless device, comprises receiving a purchase message designating the item of interest from a wireless carrier associated with the wireless device user at a messaging inter-carrier vendor, extracting data elements from the purchase message, validating the extracted data elements, and forwarding the purchase message from the messaging inter-carrier vendor to a service provider.

According to another exemplary aspect of the present invention, a system for facilitating a transaction related to an item of interest identified by a user of a mobile device comprises a messaging inter-carrier vendor linked to a wireless carrier associated with the mobile device. The messaging inter-carrier vendor is configured to receive one or more of an item identifier message and a purchase message associated with an item of interest, wherein information contained in the item identifier message and purchase message includes a destination address of a service provider associated with the item of interest and item identifier information. The system further includes one or more service providers linked to the messaging inter-carrier vendor, wherein the messaging inter-carrier vendor is configured to send the item identifier message to a designated service provider of the one or more service providers based on the information in the item identifier message.

According to another exemplary aspect of the present invention, a method for providing information to a wireless device user comprises receiving an item inquiry message from a wireless service provider associated with the user at a service provider, wherein the item inquiry message includes an item identifier associated with an item of interest and a destination address of a service provider associated with the item of interest, and sending an inquiry response message from service provider to the wireless service provider, the inquiry response message including information associated with the item of interest.

These and other features of embodiments of the present invention will be more fully explained below in conjunction with the drawings.

### BRIEF DESCRIPTION OF THE DRAWINGS

FIG. 1 is a diagrammatic presentation of an exemplary user experience that may be realized through the present invention.

FIG. 2 is a schematic diagram illustrating the relative locations of an Inter-Carrier Vendor (ICV), WCs, and a Service Provider (SP) in accordance with embodiments of the invention.

### DETAILED DESCRIPTION OF THE INVENTION

The following hypothetical example is presented to better convey the particulars of the present invention.

In this example, Alice is a potential Service User (SU) who finds herself in a store and desires to utilize the instant service as offered by a SP to learn more about, and possibly purchase, an item (also termed “the instant item” or the “item of interest” hereinafter).

Optionally, Alice may have previously completed a registration process with the SP, using as one possible example a publicly-available Web-based interface that the SP provides at a known (and, for example, advertised) Uniform Resource Locator (URL) or Web-address, during which Alice provided, and the SP stored or preserved, various identification information (including, inter alia, her mailing address, her mobile telephone number, her e-mail address, a selected password, etc.), various financial information (including, inter alia, credit card number[s], debit card number[s], checking account number[s], etc.), various demographic information (including, inter alia, her age, her product preferences, etc.), and possibly other information.

The registration process may have concluded with the SP dispatching to Alice's mobile telephone an (SMS, MMS, etc.) ‘acceptance’ message and Alice affirmatively acknowledging the exchange by dispatching a ‘reply’ message back to the SP.

In the store (or from any other venue), Alice uses her mobile telephone to capture (e.g., take a picture of, scan, etc.) the UPC or bar code of the instant item.

Alice then composes a (‘inquiry’) message, directed to a destination address as provided by the SP, requesting information about the instant item. Following the successful receipt and processing of Alice's message (described in detail below), Alice receives from the SP one or more ‘response’ messages containing information about the instant item.

The response messages may contain, possibly among other information, the name of and a brief description of the instant item, as well as a list of the stores that are near Alice's current physical location that stock or carry the instant item along with, for each listed store, an availability indicator (e.g, is the instant item in stock?) and pricing details (e.g., list price, sale price, etc.).

As Alice reviews the returned list of stores, Alice may optionally elect to purchase the instant item from one of the listed stores by dispatching a ‘purchase’ message. After receiving Alice's message and completing the purchase transaction (using, for example, the mailing address, credit card, etc. information that the SP had previously collected from Alice and then stored or preserved) the SP may dispatch a ‘confirmation’ message to Alice's mobile telephone and/or send a ‘confirmation’ e-mail message to Alice's computer.

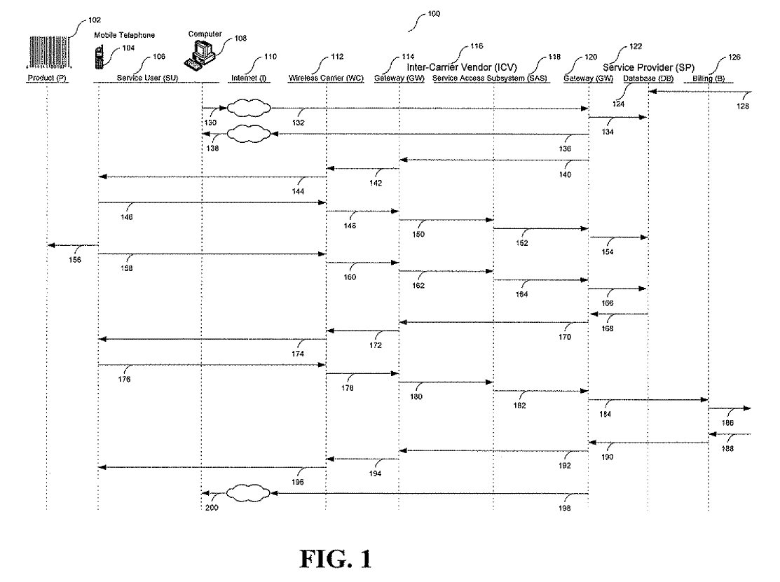

The hypothetical example presented above may be better and more fully understood through the following discussion of FIG. 1. Notably, in the discussion to follow, reference is made to messages that are sent, for example, between a mobile telephone user (Alice) and an SP. As set forth below, a given “message” sent between Alice and an SP may actually comprise a series of steps in which the message is received, forwarded and routed between different entities, including a mobile phone associated with Alice, a wireless carrier, an inter-carrier vendor, and a service provider. Thus, unless otherwise indicated, it will be understood that reference to a particular message, such as, for example, an item identifier message, generally includes that particular message as conveyed at any stage between an origination source, such as Alice's mobile phone, and an end receiver, such as an SP. As such, reference to a particular message generally includes a series of related communications between, for example, Alice and a wireless carrier, the wireless carrier and an inter-carrier vendor, and the inter-carrier vendor and an SP. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

Alice 106, the potential SU, uses her computer 108 to visit 130/132/136/138, through, for example, the Internet 110, a Web site that the SP 122 provides at a known (and for example advertised) URL or Web-address.

While at the Web site, Alice 106 completes a registration process during which she provides various identification information (including, inter alia, her mailing address, her mobile telephone number, her e-mail address, a selected password, etc.), various financial information (including, inter alia, credit card number[s], debit card number[s], checking account number[s], etc.), various demographic information (including, inter alia, her age, her product preferences, etc.), and possibly other information. The SP 122 preserves 134 the provided information in its Database (DB) 124 environment.

Following the successful completion of the registration process, the SP 122 dispatches a (e.g., SMS, MMS, etc.) ‘acceptance’ message 140 to Alice's mobile telephone 104 via a messaging Inter-Carrier Vendor (ICV) 116.

U.S. patent application No. 10/426,662, entitled “AN INTERMEDIARY NETWORK SYSTEM AND METHOD FOR FACILITATING MESSAGE EXCHANGE BETWEEN WIRELESS NETWORKS,” incorporated herein by reference in its entirety, provides a description of a messaging ICV 116 and a summary of various of the services/functions/etc. that are performed by the ICV.

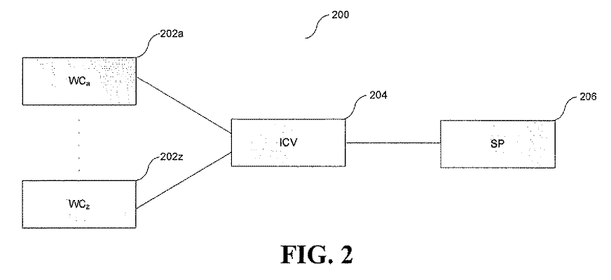

The use of messaging ICV 16, although not required, provides significant advantages. As shown, for example, in FIG. 2, a messaging ICV 204 (e.g., messaging ICV 116 from FIG. 1) is disposed between (that is, communicatively linked to) multiple WCs 202a. . . 202z (e.g., including WC 112 from FIG. 1) on one side and a SP 206 (e.g., SP 122 from FIG. 1) on the other side. Consequently, as long as messaging ICV 116 from FIG. 1 has a relationship with Alice's particular WC (WC 112 from FIG. 1) Alice can obtain access to the services offered by SP 122 from FIG. 1. In one configuration of the present invention, a messaging ICV, such as ICV 204, is linked to a plurality of service providers. In other words, SP 206 can be considered to represent more than one service provider, each of which is linked to ICV 204. Thus, in one embodiment of the present invention, as long as messaging ICV 116 from FIG. 1 has a relationship with Alice's particular WC (WC 112 from FIG. 1), Alice will be able to obtain access to the services offered by SP 122 from FIG. 1, where SP 122 represents any of a plurality of service providers linked to ICY 116.

Referring again to FIG. 1, message 140 may optionally contain an informational message—e.g., ‘Thank you for registering for our service!’, etc. The informational message may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a Location Based Service [LBS] facility).

The message 140 may optionally contain advertising—e.g., textual material if an SMS model is being utilized, or multimedia (images of brand logos, sound, video snippets, etc.) material if an MMS model is being utilized. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, an LBS facility).

The Gateway (GW) 114 within the messaging ICV 116 receives the message 140, examines the destination address (i.e., the Telephone Number [TN] of Alice's mobile telephone 104, perhaps 703-555-4321), identifies the destination (i.e., Alice's) WC 112, and appropriately routes received message 140 as message 142.

Alice's WC 112 receives the message 142, examines the destination address (i.e., the TN of Alice's mobile telephone 104), and delivers received message 142 as message 144 to Alice's mobile telephone 104. To indicate her acceptance of, and consequently to finalize, the registration process, Alice dispatches from her mobile telephone 104 a ‘reply’ 146 to the received message 144.

The reply message 146 may be addressed to a TN, e.g., 703-555-1234. Alternatively, the reply message 146 may be addressed to a Common Short Code (CSC), e.g., 12345. A description of a common (i.e., universal) short code environment may be found in U.S. patent application Ser. No. 10/742,764 entitled “UNIVERSAL SHORT CODE ADMINISTRATION FACILITY, incorporated herein by reference is in its entity.

Alice's WC 112 receives Alice's reply message 146, examines the destination address (e.g., the TN or the CSC), identifies the destination address as residing outside of its network, and passes the reply message as message 148 along to its messaging ICV 116 for processing.

A GW 114 that is located at Alice's WC's 112 messaging ICY 116 receives Alice's reply message 148 and examines the destination address of the received reply message 148, determines that the message should be processed by a Service Access Subsystem (SAS) 118, and appropriately routes the reply message as message 150.

The SAS 118 receives Alice's reply message 150 and, possibly among other activities, extracts key data elements from the message 150, validates the extracted data elements, and then, acting as a facade or an interface to all of the SPs that the ICV 116 supports, dispatches the reply message as message 152 to the SP 122.

A GW 120 at the SP 122 receives Alice's reply message 152, extracts key data elements from the message 152, validates the extracted data elements, and then, possibly among other activities, updates 154 the entries for Alice that it maintains in its DB 124 environment.

At some later time Alice finds herself in a store (or some other venue or location) and desires to learn more about, and possibly purchase, an item.

On her mobile telephone 104 Alice captures (e.g., takes a picture of, scans, manually enters the number of etc.) 156 the UPC or bar code 102 of the instant item, or otherwise captures information that provides a basis for identification of the item. For example, a picture of the item of interest may be sufficient to identify it. Alice then composes an inquiry message (also termed “item inquiry message”) 158, directed to a destination address (e.g., a TN or a CSC) as provided by the SP 122, requesting information about the instant item.

Alice's WC 112 receives Alice's item inquiry message 158, examines the destination address (e.g., the TN or the CSC), identifies the destination address as residing outside of its network, and passes the inquiry message as message 160 along to its messaging ICV 116 for processing.

GW 114 receives Alice's inquiry message 160 and examines the destination address of the received inquiry message 160, determines that the message should be processed by a SAS 118, and appropriately routes the inquiry message as message 162.

The SAS 118 receives Alice's inquiry message 162 and, possibly among other activities, extracts key data elements from the message 162, validates the extracted data elements, optionally performs other processing activities, and then dispatches the message as message 164 to the SP 122.

GW 120 receives Alice's inquiry message 164, extracts key data elements from the message 164, validates the extracted data elements (possibly including, inter alia, a determination that Alice is an allowed user of the instant service, a decoding of the UPC or bar code 102 to identify the instant item, etc.), and then, possibly among other activities, sends a query 166 to its DB 124 environment.

In response to the query 166, database 124 returns an inquiry response message 168 that includes identification, availability, etc. information for the instant item 102 and may optionally return 168 various identification, financial, etc. information that had been previously stored concerning Alice and a (‘response’) message 170 is dispatched that contains the returned information 168.

The response message 170 may contain, possibly among other information, the item name and a brief description of the instant item 102, as well as a list of the stores that are near Alice's current physical location (correlated, for example, through a LBS facility) that stock or carry the instant item 102 along with, for each listed store, an availability indicator (e.g., is the instant item in stock?) and pricing details (e.g., list price, sale price, etc.).

The response message 170 may optionally contain promotional materials (e.g., still images, video clips, etc.) for the instant item 102 that have been provided previously by the supplier(s) of the item.

The response message 170 may optionally contain an informational message and/or advertising (through a mechanism similar to what was described above with respect to message 140).

The GW 114 within the messaging ICV 116 receives the response message 170, examines the destination address (i.e., the TN of Alice's mobile telephone 104), identifies the destination (i.e., Alice's) WC 112, and appropriately routes the message as message 172.

Alice's WC 112 receives the response message 172, examines the destination address (i.e., the TN of Alice's mobile telephone 104), and delivers the message as message 174 to Alice's mobile telephone 104. if needed, the SP 122 may dispatch additional response messages (e.g., ‘2 of n’ and ‘3 of n’ and ‘4 of n’ and . . . ) to Alice's mobile telephone 104 by repeating the message sequence 170/172/174 the required number of times (to fully convey to Alice all of the returned information 168).

After reviewing the returned list of stores, Alice may optionally elect to receive farther information about a specific store. That information, the generation of which may leverage LBS-based facilities, may include possibly among other things the address of the store, descriptive travel directions from Alice's current physical location to the store, a map showing travel directions to the store, etc.

After reviewing the returned list of stores, Alice may optionally elect to purchase the instant item 102 from one of the listed stores by dispatching a new (‘purchase’) message 176.

Alice's WC 112 receives Alice's purchase message 176, examines the destination address (e.g., the TN or the CSC), identifies the destination address as residing outside of its network, and passes the purchase message as message 178 along to its messaging ICV 116 for processing.

GW 114 receives Alice's purchase message 178 and examines the destination address of the received purchase message 178, determines that the message should be processed by a SAS 118, and appropriately routes the purchase message as message 180.

The SAS 118 receives Alice's purchase message 180 and, possibly among other activities, extracts key data elements from the message 180, validates the extracted data elements, and then dispatches the message as message 182 to the SP 122.

GW 120 receives Alice's purchase message 182, extracts key data elements from the message 182, validates the extracted data elements (possibly including, inter alia, a determination that Alice is an allowed user of the instant service, etc.). Subsequently, SP 122, possibly among other activities, passes 184 previously extracted/retrieved/etc. information, for example, identification, financial, etc. received during Alice's registration with SP 122 to its Billing (B) interface 126 which completes a billing transaction 186.

The billing transaction 186 may take any number of forms including, inter alias:

1) The appearance of a line item charge on the bill or statement that Alice receives from her WC 112. Exemplary mechanics and logistics associated with this approach are described in U.S. patent application Ser. No. 10/837,695 entitled “SYSTEM AND METHOD FOR BILLING AUGMENTATION,” which is incorporated herein by reference in its entirety. Other ways of line item billing are easily implemented by those skilled in the art.

2) The charging of a credit card or the debiting of a debit card. The particulars (e.g., number, expiration date) of the card that is to be used may, as one example, have been provided previously by Alice during her registration process.

3) The decrementing of a pre-paid account that Alice established previously during her registration process.

4) Other means including, inter alia, pre-paid or ‘countdown’ cards, redemption coupons, etc.

Following the successful completion 188/190 of the billing transaction 186 the SP 122 may dispatch a (‘confirmation’) message 192. The confirmation message 192 may optionally contain an informational message—e.g., ‘Thank you very much for your purchase!’—and/or advertising (using any of the approaches that were described above).

The GW 114 within the messaging ICV 116 receives the confirmation message 192, examines the destination address (i.e., the TN of Alice's mobile telephone 104), identifies the destination (i.e., Alice's) WC 112, and appropriately routes the continuation message as message 194.

Alice's WC 112 receives the confirmation message 194, examines the destination address (i.e., the TN of Alice's mobile telephone 104), and delivers the continuation message as message 196 to Alice's mobile telephone 104.

The SP 122 may optionally dispatch an e-mail message 198/200 to Alice's computer 108. The e-mail message 198/200 may optionally contain an informational message—e.g., ‘Thank you very much for your purchase!’—and/or advertising (using any of the approaches that were described above).

While not explicitly indicated in FIG. 1, the SP may optionally dispatch a ‘ship’ message/command/etc. to the store from which Alice ordered the instant item.

The ship directive may contain, for example, the mailing address information that was provided previously by Alice during her registration process, identifying information for the instant item 102, details of the previously-completed billing transaction 186/188, etc.

Entities, such as stores, may submit information 128 to the SP for recording in the SP's DB 124 environment. That information may consist oft possibly among other things, for each offered item, the name of the item and a brief description of the item, an availability indicator (e.g., is the instant item in stock?), pricing details (e.g., list price, sale price, etc.), promotional materials (e.g., still images, video clips, etc.), advertising information, etc.

It is important to note that the hypothetical example that was presented above, which was described in the narrative and which was illustrated in the accompanying figures, is exemplary only. It will be readily apparent to one of ordinary skill in the relevant art that numerous alternatives to the presented example are easily possible and, indeed, are fully within the scope of the present invention.

The discussion presented above employed two specific wireless messaging paradigms—SMS and MMS. These paradigms potentially offer an advantage over other paradigms because native support for SMS and/or MMS is commonly found on mobile telephones that a potential SU might carry. However, it is to be understood that it would be readily apparent to one of ordinary skill in the relevant art that other paradigms (such as, for example, IP Multimedia Subsystem [IMS], Wireless Application Protocol [WAP], Instant Messenger [IM], etc.) are fully within the scope of the present invention.

While the discussion that was just presented focused on UPC or bar codes on items for purchase in a store, it will be readily apparent to one of ordinary skill in the relevant art that the application of the present invention to UPC or bar codes in numerous other environments (e.g., brochures, posters, printed advertisements, etc.) for numerous other purposes (e.g., making charitable donations, purchasing concert tickets, etc.) is easily possible and, indeed, is fully within the scope of the present invention.

While the discussion that was just presented focused on using UPC or bar codes as item identify information, it will be readily apparent to one of ordinary skill in the relevant art that the application of the present invention to numerous other item identifier information (e.g., public or private, ubiquitous or exclusive, opaque or transparent, etc.) such as Vehicle Identification Numbers (VINs) is easily possible and indeed is fully within the scope of the present invention.

The following list defines acronyms as used in this disclosure.

| Acronym | Meaning |
|---|---|
| CSC | Common Short Code |
| DB | Database |
| GW | Gateway |
| ICV | Inter-Carrier Vendor |
| IM | Instant Messenger |
| IMS | IP Multimedia Subsystem |
| LBS | Location Based Service |
| MMS | Multimedia Message Service |
| MS | Mobile Subscriber |
| SAS | Service Access Subsystem |
| SMS | Short Message Service |
| SP | Service Provider |
| SU | Service User |
| TN | Telephone Number |
| UPC | Universal Product Code |
| URL | Uniform Resource Locator |
| VIN | Vehicle Identification Number |
| WAP | Wireless Application Protocol |
| WC | Wireless Carrier |
| WD | Wireless Device |

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for providing information to a wireless device user, comprising:
receiving an item inquiry message from a wireless service provider associated with the user at a messaging inter-carrier vendor;
forwarding the item inquiry message to a service provider;
receiving an inquiry response message from the service provider at the messaging inter-carrier vendor, the inquiry response message including information associated with an item of interest; and
routing the inquiry response message from the messaging inter-carrier vendor to the wireless service provider.

2. The method of claim 1, wherein the item inquiry message includes an item identifier associated with the item of interest and a destination address of a service provider associated with the item of interest.

3. The method of claim 2, wherein the item identifier includes one or more of a universal product code and an image of the item of interest.

4. The method of claim 2, wherein the destination address includes one of a telephone number and a common short code.

5. The method of claim 1, wherein the inquiry response message includes at least three of,
a description of the item of interest;
a list of stores carrying the item of interest and located near a current location of the user;
an availability indicator associated with the item of interest;
pricing details associated with the item of interest;
promotional materials associated with the item of interest;
advertising;
randomly generated information; and
other information based on the current location of the user.

6. The method of claim 1, further comprising, routing the inquiry message to a services access subsystem of the messaging inter-carrier vendor.

7. The method of claim 1, wherein the item inquiry message is one of an SMS message, an MMS message, an IMS message a WAP message, and an IM message.

8. The message of claim 1, wherein the wireless device is a mobile telephone.

9. The method of claim 1, further comprising:
extracting data elements of the item identifier message;
validating the extracted data elements; and
sending a database query to a database associated with the service provider.

10. The method of claim 9, further comprising returning information associated with the user in response to the database query.

11. The method of claim 1 wherein the inquiry response messages comprises a series of response messages that collectively include at least three of:
a description of the item of interest;
a list of stores carrying the item of interest and located near a current location of the user;
an availability indicator associated with the item of interest;
pricing details associated with the item of interest;
promotional materials associated with the item of interest;
advertising;
randomly generated information; and
other information based on the current location of the user.

12. The method of claim 1, wherein the inquiry response message is one of an SMS message, an MMS message, an IMS message, a WAP message, and an IM message

13. A method of registering a mobile device user associated with a wireless carrier with a service provider for purposes of future sales transactions, comprising:
storing identification information associated with the mobile device user at a database of the service provider,
receiving an acceptance message, initiated by the service provider, at a messaging inter-carrier vendor;
routing the acceptance message from the messaging inter-carrier vendor to the wireless carrier;
receiving a reply message, initiated by the mobile service device user, from the wireless carrier at the messaging inter-carrier vendor;
forwarding the reply message to the service provider; and
updating user entries associated with the mobile device user at the service provider.

14. The method of claim 13, further comprising:
extracting data elements from the reply message; and
validating the extracted data elements.

15. The method of claim 13, wherein the identification information includes one or more of a user mailing address, a user mobile telephone number, a user e-mail address, a selected password, a user credit card number, a user debit card number, a user checking account number, a user age, and user product preferences.

16. The method of claim 13, wherein the identification information is received at the service provider via a data network.

17. The method of claim 13, wherein the acceptance message is one an SMS message, an MMS message, an IMS message, a WAP message, and an IM message.

18. The method of claim 13, wherein the reply message is one of an SMS message, an MMS message, an IMS message, a WAP message, and an IM message.

19. The method of claim 13, wherein the acceptance message comprises one of a statically generated message, a randomly generated message, and a location based message.

20. The method of claim 19, wherein the acceptance message comprises advertising.

21. A method for facilitating a purchase of an item of interest by a user of a wireless device, comprising:
receiving a purchase message designating the item of interest from a wireless carrier associated with the wireless device user at a messaging inter-carrier vendor;
extracting data elements from the purchase message;
validating the extracted data elements; and
forwarding the purchase message from the messaging inter-carrier vendor to a service provider.

22. The method of claim 21, further comprising routing the purchase message to a service access subsystem of the messaging inter-carrier vendor.

23. The method of claim 21, further comprising:
retrieving user information related to the wireless device user received in a registration process;
forwarding the user information and the extracted data elements to a billing interface; and
completing a billing transaction related to the item.

24. The method of claim 23, wherein the billing transaction comprises one of a line item charge from the wireless carrier, a charge on a credit card account, a debit made to a debit card account, a decrement in a pre-paid account established during the registration process, use of prepaid cards, and use of redemption coupons.

25. The method of claim 21, further comprising
receiving a confirmation message from the service provider at the messaging inter-carrier vendor;
forwarding the confirmation message from the messaging inter-carrier vendor to the wireless carrier; and
sending the confirmation message to the wireless device.

26. The method of claim 25, wherein the confirmation message comprises at least one of an informational message and an advertising message.

27. The method of claim 21, further comprising sending the confirmation message from the service provider to a computer associated with the wireless device user.

28. The method of claim 27, wherein the confirmation message comprises at least one of an informational message and an advertising message.

29. The method of claim 21, wherein the purchase message is one of an SMS message, an MMS message, an IMS message, a WAP message, and an IM message.

30. The method of claim 21, wherein the confirmation message is one of an SMS message, an MMS message, an IMS message, a WAP message, and an IM message.

31. The method of claim 21, wherein the purchase message includes a designated store that carries the item of interest.

32. The message of claim 32, further comprising, prior to receiving the purchase message:
sending, from the inter-carrier vendor to the wireless carrier, a list of stores located near the user that carry the item of interest;
receiving, at the inter-carrier vendor, a designated store; and
sending, from the inter-carrier vendor to the wireless carrier, one or more of an address of the designated store, descriptive travel directions from a current user location to the designated store, and a map containing travel directions from a current user location to the designated store.

33. A system for facilitating a transaction related to an item of interest identified by a user of a mobile device, comprising:
a messaging inter-carrier vendor linked to a wireless carrier associated with the mobile device, the messaging inter-carrier vendor configured to receive one or more of an item identifier message and a purchase message associated with the item of interest, wherein information contained in the item identifier message and purchase message includes a destination address of a service provider associated with the item of interest and item identifier information; and
one or more service providers linked to the messaging inter-carrier vendor, wherein the messaging inter-carrier vendor is configured to send the item identifier message to a designated service provider of the one or more service providers based on the information in the item identifier message.

34. The system of claim 33, wherein the item identifier information comprises one or more of a universal product code information, vehicle identification number (VIN) information, and an image of the item of interest.

35. The system of claim 34, wherein the universal product code information comprises one or more of scanned bar code information, manually entered numbers associated with the universal product code, and an image of a bar code.

36. The system of claim 33, wherein the destination address of the service provider is one of a telephone number and a common short code.

37. The system of claim 33, wherein the purchase message includes designation of the item of interest.

38. The system of claim 33, wherein one or more of the item identifier message and the purchase message are one of an SMS message, an MMS message, an IMS message, a WAP message, and an IM message.

39. The system of claim 33, wherein the messaging inter-carrier vendor comprises a service access subsystem that is linked to the one or more service providers and is configured to perform one or more of extracting data elements from the item identifier and purchase messages, validating the extracted data elements, and forwarding the purchase and item identifier messages to a service provider.

40. The system of claim 39, wherein the messaging inter-carrier vendor comprises a gateway that is configured to receive the purchase message and item identifier message and forward the purchase and item identifier messages to the service access subsystem based on the destination address.

41. A method for providing information to a wireless device user, comprising:
receiving an item inquiry message from a wireless service provider associated with the user at a service provider, wherein the item inquiry message includes an item identifier associated with an item of interest and a destination address of a service provider associated with the item of interest; and
sending an inquiry response message from service provider to the wireless service provider, the inquiry response message including information associated with the item of interest.

42. The method of claim 41, wherein the item identifier includes one or more of a universal product code and an image of the item of interest, and wherein the destination address includes one of a telephone number and a common short code.

43. The method of claim 41, wherein the inquiry response message includes at least three of:
a description of the item of interest;
a list of stores carrying the item of interest and located near a current location of the wireless device user;
an availability indicator associated with the item of interest;
pricing details associated with the item of interest;
promotional materials associated with the item of interest;
advertising;
randomly generated information; and
other information based on the current location of the user.
